(19) United States
(12) Patent Application Publication
(10) Pub. No.: US 2026/0225039 A1
(43) Pub. Date: Aug. 6, 2026

(54) THREE-STAGE CONTINUOUS CO2 CAPTURE DEVICE AND METHOD BASED ON HYDRATE TECHNOLOGY

(71) Applicant: DALIAN UNIVERSITY OF TECHNOLOGY, Dalian (CN)

(72) Inventors: Yongchen SONG, Dalian (CN); Bingbing CHEN, Dalian (CN); Jing CHEN, Dalian (CN); Mingjun YANG, Dalian (CN); Huiru SUN, Dalian (CN); Lanlan JIANG, Dalian (CN); Yu LIU, Dalian (CN)

(21) Appl. No.: 19/574,969

(22) Filed: Mar. 23, 2026

(30) Foreign Application Priority Data
Apr. 2, 2025 (CN) 202510410107.1

(51) Int. Cl. B01D 53/62; B01D 53/14; B01D 53/18; B01D 53/30; B01D 53/78; B01D 53/96; C01B 32/50

(52) U.S. Cl. CPC B01D 53/62; B01D 53/1412; B01D 53/1418; B01D 53/1425; B01D 53/1475; B01D 53/1493; B01D 53/18; B01D 53/30; B01D 53/78; B01D 53/96; C01B 32/50; B01D 2252/103; B01D 2256/22; B01D 2257/504

(57) ABSTRACT

The present invention provides a three-stage continuous CO₂ capture device and method based on hydrate technology. By utilizing the emerging hydrate-based carbon capture technology, a novel three-stage device structure is designed, along with an optimized operational workflow. Through completing the following processes: \textcircled{1} preparation process, \textcircled{2} hydrate generation process, \textcircled{3} gas concentration detection process, \textcircled{4} hydrate slurry transfer process I, \textcircled{5} transfer process II, \textcircled{8} hydrate decomposition process, \textcircled{9} CO₂ gas collection process, \textcircled{10} solution recovery process and \textcircled{11} completion process, the invention addresses the issues of low efficiency and clogging in hydrate-based carbon capture. It achieves the goal of large-scale continuous CO₂ separation and capture, enhances energy-saving benefits, and is conducive to the industrial-scale promotion and application of hydrate-based carbon capture technology.

### TECHNICAL FIELD

The present invention belongs to the field of hydrate technology application, and specifically relates to a three-stage continuous CO₂ capture device and method based on hydrate technology.

### BACKGROUND TECHNOLOGY

The acceleration of global industrialization and urbanization has led to a rise in greenhouse gas emissions, particularly CO₂, causing climate change and environmental issues. These problems pose a threat to ecosystems and have a serious impact on human economic activities and daily life. Therefore, reducing CO₂ emissions has become a critical global issue.

However, traditional carbon capture technologies are still limited by high energy consumption, stringent operating conditions and the unstable performance of carbon capture materials. More efficient, green and sustainable carbon capture technologies need to be developed.

Hydrate technology is an emerging form of carbon capture. Hydrates are non-stoichiometric crystalline cage compounds formed from gas and water molecules under low temperatures and high pressures. They offer the advantage of a large gas storage capacity: 1 m³ of hydrate can store 160-180 m³ of gas under standard conditions. Due to the unique physicochemical properties of hydrates, this technology can be applied in CO₂ capture. However, the natural formation rate of hydrates is slow, and the structure and design of traditional systems often result in hydrate clumping, causing blockages in reactors or pipelines. This prevents dynamic and continuous capture, hindering the realization of large-scale industrial production and limiting the widespread application of hydrate technology. Therefore, further research and improvements are needed to enhance hydrate-based carbon capture solutions.

### CONTENT OF THE INVENTION

Based on the above problems, the present invention utilizes the hydrate-based targeted CO₂ capture technology and designs a novel three-stage device structure, along with an optimized operational workflow. This solution effectively resolves the problems of low efficiency and clogging commonly associated with hydrate-based carbon capture methods. The invention provides a three-stage continuous CO₂ capture device and method based on hydrate technology.

The technical program of the present invention: A three-stage continuous CO₂ capture device based on hydrate technology, comprising: a hydrate generation vessel 1, a gas composition detector 2, a connection valve I 3, an intermediate vessel 4, a gas pump 5, a connection valve II 6, a hydrate decomposition vessel 7, ports, a mechanical stirrer I 9, valves, a pressure sensor I 11, a sight glass I 12, a temperature sensor I 13, a jacket I 14-1, a jacket II 14-2, fixing bolts 15, a sight glass II 16, a temperature sensor II 17, a mechanical stirrer II 18, a one-way valve 19, a pressure sensor II 20, a booster pump 21, a gas source 22, a solution storage tank 23, a water pump 24, a water bath I 25, a water bath II 26, a signal processor 27 and a decomposition gas collection bottle 28;
the main body of the device is a three-stage device, which is provided with the hydrate generation vessel 1, the connection valve I 3, the intermediate vessel 4, the connection valve II 6 and the hydrate decomposition vessel 7 from top to bottom in sequence;
the hydrate generation vessel 1 is a stainless steel cylindrical pressure-resistant container, with the sight glass I 12 installed at half of the height thereof, and the jacket I 14-1 welded around the outer perimeter thereof; a top cover and a bottom cover of the hydrate generation vessel 1 are respectively provided with evenly distributed fixing bolts 15; the top cover of the hydrate generation vessel 1 is provided with seven holes at a diameter position, through which the following components are installed from left to right in sequence: a gas injection port 8-1, a water injection port 8-2, a residual waste gas discharge port 8-3, a mechanical stirrer I installation port 8-11, a pressure sensor I port 8-6, a gas composition detection port 8-5 and a temperature sensor I port 8-4; a motor part of the mechanical stirrer I 9 is located outside the top cover of the hydrate generation vessel 1, while a main shaft of the mechanical stirrer I 9 extends into the hydrate generation vessel 1; the pressure sensor I port 8-6 is connected upwards to the pressure sensor I 11, and the temperature sensor I port 8-4 is connected upwards to the temperature sensor I 13; the bottom of the hydrate generation vessel 1 is provided with a communication hole which is connected to the connection valve I 3 below;
a valve chamber passage of the connection valve I 3 is aligned with the communication hole in the bottom cover of the hydrate generation vessel 1, a valve stem of the connection valve I 3 is horizontally connected to a valve body and a drive shaft of the connection valve I 3, and the bottom of the connection valve I 3 is connected to a top cover communication hole of the intermediate vessel 4;
the intermediate vessel 4 is a stainless steel cylindrical pressure-resistant container, a top cover and a bottom cover are respectively provided with evenly distributed fixing bolts 15 and communication holes, the top cover is provided with a decomposition gas discharge port 8-7, and a communication hole in the bottom of the intermediate vessel 4 is connected to the connection valve II 6 below;
the valve chamber passage of the connection valve II 6 is aligned with the communication holes at the top cover of the hydrate decomposition vessel 7. The valve stem of the connection valve II 6 is horizontally connected to the valve body and the drive shaft. The bottom of the connection valve II 6 is connected to the top cover connecting hole of the hydrate decomposition vessel 7;

a valve chamber passage of the connection valve II 6 is aligned with the communication hole in a top cover of the hydrate decomposition vessel 7, a valve stem of the connection valve II 6 is horizontally connected to a valve body and a drive shaft of the connection valve II 6, and the bottom of the connection valve II 6 is connected to a top cover communication hole of the hydrate decomposition vessel 7;
the hydrate decomposition vessel 7 is a stainless steel cylindrical pressure-resistant container, with the sight glass II 16 installed at half of the height thereof, and the jacket II 14-2 welded around the outer perimeter thereof; the top cover and a bottom cover of the hydrate decomposition vessel 7 are respectively provided with evenly distributed fixing bolts 15; the top cover of the hydrate decomposition vessel 7 is provided with a communication hole which is connected to the connection valve II 6 above; the bottom cover of the hydrate decomposition vessel 7 is provided with five holes at a diameter position, through which the following components are installed from left to right in sequence: a liquid discharge port 8-8, a mechanical stirrer II installation port 8-12, a pressure sensor II port 8-9 and a temperature sensor II port 8-10; a motor part of the mechanical stirrer II 18 is located outside the bottom cover of the hydrate decomposition vessel 7, while a main shaft of the mechanical stirrer II 18 extends into the hydrate decomposition vessel 7; the pressure sensor II port 8-9 is connected downwards to the pressure sensor II 20, and the temperature sensor II port 8-10 is connected downwards to the temperature sensor II 17;
the device comprises the following routes: a gas injection route, a waste gas discharge route, a solution circulation route, a solution supply route, a solution recirculation route, a solution recovery route, a gas concentration detection route, a signal transmission route, a decomposition gas collection route, a refrigeration route and a heating route;
the routes of the device are specifically as follows:
gas injection route: the gas source 22 is connected to the gas injection port 8-1 of the hydrate generation vessel 1 through a fourth valve 10-4, the booster pump 21 and a pipeline III;
waste gas discharge route: the residual waste gas discharge port 8-3 of the hydrate generation vessel 1 is connected to the atmosphere through a second valve 10-2 and a pipeline I;
solution circulation route: starting from the water injection port 8-2 of the hydrate generation vessel 1, the route is connect to a pipeline IX through a pipeline II and a third valve 10-3; the pipeline IX is divided into two branches at the end; a left branch is connected to the top end of the solution storage tank 23 through a fifth valve 10-5 and a pipeline X, and the bottom end of the solution storage tank 23 is connected to a pipeline XIII through a sixth valve 10-6 and a pipeline XII; a right branch is connected to the water pump 24 through a pipeline XI, and is then merged with the pipeline XIII through a seventh valve 10-7; at the junction, the route is connected to the liquid discharge port 8-8 of the hydrate decomposition vessel 7 through an eighth valve 10-8 and a pipeline XIV;
solution supply route: the bottom end of the solution storage tank 23 is connected to the water injection port 8-2 of the hydrate generation vessel 1 through the sixth valve 10-6, the pipeline XII, the pipeline XIII, the seventh valve 10-7, the water pump 24, the pipeline XI, the pipeline IX, the third valve 10-3 and the pipeline II;
solution recirculation route: the liquid discharge port 8-8 of the hydrate decomposition vessel 7 is connected to the water injection port 8-2 of the hydrate generation vessel 1 through the pipeline XIV, the eighth valve 10-8, the seventh valve 10-7, the water pump 24, the pipeline XI, the pipeline IX, the third valve 10-3 and the pipeline II;
solution recovery route: the liquid discharge port 8-8 of the hydrate decomposition vessel 7 is connected to the top end of the solution storage tank 23 through the pipeline XIV, the eighth valve 10-8, the seventh valve 10-7, the water pump 24, the pipeline XI, the fifth valve 10-5 and the pipeline X;
gas concentration detection route: the gas composition detection port 8-5 of the hydrate generation vessel 1 is connected to the gas composition detector 2 through a first valve 10-1 and a pipeline V;
signal transmission route 1: the pressure sensor I 11 is connected to the signal processor 27 through a signal circuit IV;
signal transmission route 2: the rear end of the gas composition detector 2 is connected to the signal processor 27;
signal transmission route 3: the temperature sensor I 13 is connected to the signal processor 27 through a signal circuit VI;
signal transmission route 4: the pressure sensor II 20 is connected to the signal processor 27 through a signal circuit XV;
signal transmission route 5: the temperature sensor II 17 is connected to the signal processor 27 through a signal circuit XIX;
decomposition gas collection route: the decomposition gas discharge port 8-7 of the intermediate vessel 4 is connected to the decomposition gas collection bottle 28 through a ninth valve 10-9, a pipeline XVI, and the gas pump 5;
refrigeration route: the jacket I 14-1 is connected to a liquid outlet of the water bath I 25 through a pipeline VIII, and the jacket I 14-1 is connected to a liquid return port of the water bath I 25 through a pipeline VII;
heating route: the jacket II 14-2 is connected to a liquid outlet of the water bath II 26 through a pipeline XVIII, and the jacket II 14-2 is connected to a liquid return port of the water bath II 26 through a pipeline XVII.
in further detail, the bottom end of the main shaft of the mechanical stirrer I 9 is 10 cm from the bottom cover of the hydrate generation vessel 1, and paddle-type stirring blades are welded on the main shaft; the blades are distributed in pairs on the main shaft at equal intervals from top to bottom, a first group is positioned 10 cm from the top end of the main shaft, and a last group is welded on the bottom end of the main shaft.
in further detail, the bottom end of the main shaft of the mechanical stirrer II 18 is 10 cm from the top end of the hydrate decomposition vessel 7, and paddle-type stirring blades are welded on the main shaft; the blades are distributed in pairs on the main shaft at equal intervals from top to bottom, a first group is positioned 10 cm from the top end of the main shaft, and a last group is welded on the bottom end of the main shaft.
in further detail, the internal volume of the hydrate generation vessel 1 is V, the internal volume of the intermediate vessel 4 is ⅔V, and the internal volume of the hydrate decomposition vessel 7 is also ⅔ V.
in further detail, the gas source 22 is a pressure-resistant container rated for 10 MPa, with a volume of >10V, and is used for storing a mixed gas of CO₂ and N₂ as a feed gas of the device; the solution storage tank 23 has a volume of ≥2V; the decomposition gas collection bottle 28 is a pressure-resistant container rated for 10 MPa, with a volume of ≥10V, and is used for storing pure CO₂.

### Beneficial Effects of the Present Invention

The present invention proposes a three-stage continuous CO₂ capture device and method based on hydrate technology. By utilizing this novel hydrate technology, it achieves the large-scale continuous separation and capture of CO₂. The purified CO₂ also holds further economic value. This invention provides new insights for the design of hydrate-based CO₂ capture devices and processes, and offers significant implications for the subsequent research on hydrate applications.

### ILLUSTRATE WITH DIAGRAMS

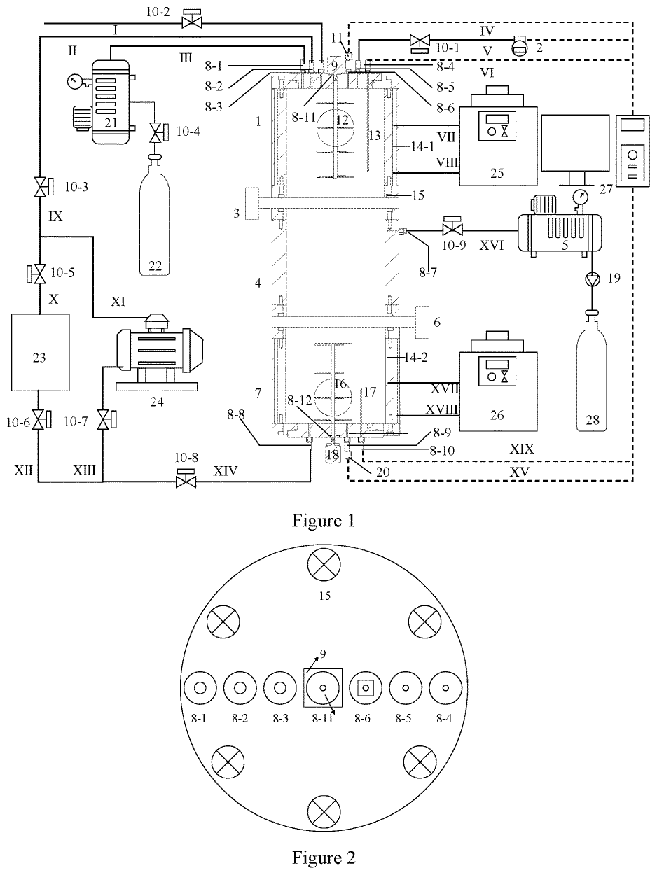

FIG. 1 shows a general diagram of a three-stage continuous CO2 capture device and method based on hydrate technology.

FIG. 2 shows a top view schematic diagram of the hydrate generation vessel top cover in FIG. 1.

FIG. 3 shows a top view schematic diagram of the intermediate vessel top cover in FIG. 1.

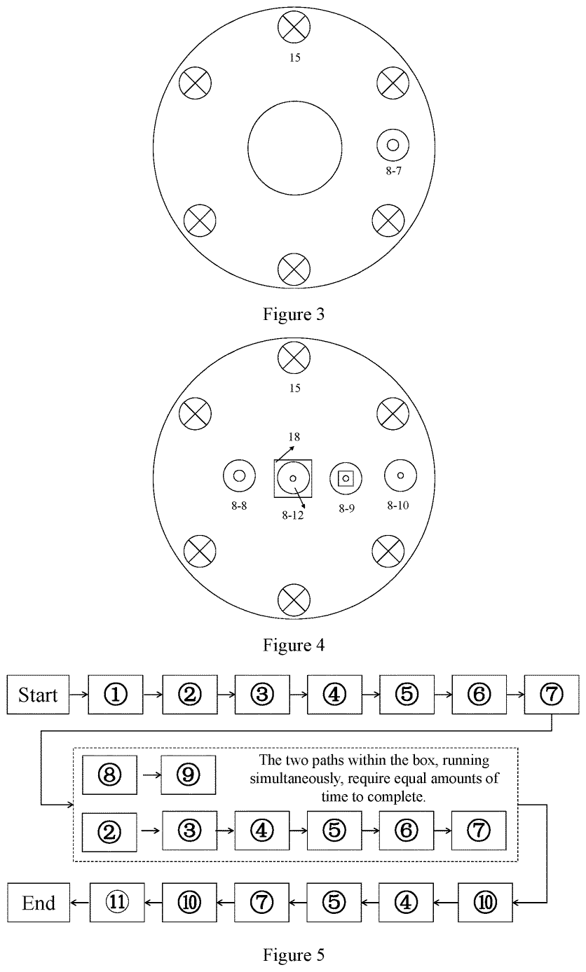

FIG. 4 shows a upward view schematic diagram of the hydrate decomposition vessel bottom cover in FIG. 1.

FIG. 5 shows the workflow chart of the process in FIG. 1.

In the figure: 1 hydrate generation vessel, 2 gas composition detector, 3 connection valve I, 4 intermediate vessel, 5 gas pump, 6 connection valve II, 7 hydrate decomposition vessel, 8-1 gas injection port; 8-2 water injection port; 8-3 residual waste gas discharge port; 8-4 temperature sensor I port; 8-5 gas composition detection port; 8-6 pressure sensor I port; 8-7 decomposition gas discharge port; 8-8 liquid discharge port; 8-9 pressure sensor II port; 8-10 temperature sensor II port; 8-11 mechanical stirrer I installation port; 8-12 mechanical stirrer II installation port; 9 mechanical stirrer I; 10-1 first valve; 10-2 second valve; 10-3 third valve; 10-4 fourth valve; 10-5 fifth valve; 10-6 sixth valve; 10-7 seventh valve; 10-8 eighth valve; 10-9 ninth valve; 11 pressure sensor I, 12 sight glass I, 13 temperature sensor I, 14-1 jacket I, 14-2 jacket II, 15 fixing bolts, 16 sight glass II, 17 temperature sensor II, 18 mechanical stirrer II, 19 one-way valve, 20 pressure sensor II, 21 booster pump, 22 gas source, 23 solution storage tank, 24 water pump, 25 water bath I, 26 water bath II, 27 signal processor and 28 decomposition gas collection bottle;

### SPECIFIC EMBODIMENTS

Specific embodiments of the present invention are further described below in connection with the technical scheme and the accompanying drawings.

A method for using the three-stage continuous CO₂ capture device based on hydrate technology comprises the following processes: \textcircled{1} preparation process, \textcircled{2} hydrate generation process, \textcircled{3} gas concentration detection process, \textcircled{4} hydrate slurry transfer process I, \textcircled{5} waste gas discharge process, \textcircled{6} solution recirculation process, \textcircled{7} hydrate slurry transfer process II, \textcircled{8} hydrate decomposition process, \textcircled{9} CO₂ gas collection process, \textcircled{10} solution recovery process and \textcircled{11} completion process;
according to a chronological order, the operation of the device is divided into three stages; the first stage is \textcircled{1}→\textcircled{2}→\textcircled{3}→\textcircled{4}→\textcircled{5}→\textcircled{6}→\textcircled{7}; after process 7, the second stage of the operation of the device occurs; the second stage is divided into two concurrent routes: route 1 is \textcircled{8}→\textcircled{9}, and route 2 is \textcircled{2}→\textcircled{3}→\textcircled{4} \textcircled{5}→\textcircled{6}→\textcircled{7}; both routes start and end simultaneously, and the total time spent is equal; after repeating the second stage for N times, the third stage of the operation of the device is carried out, which is \textcircled{10}→\textcircled{4}→\textcircled{5}→\textcircled{7}→\textcircled{10}→\textcircled{11}; thus, the entire continuous carbon capture work is completed.

### \textcircled{1} Preparation Process

before the device starts operation, all valves are kept in a closed position, and a certain amount of solution is pre-stored in the solution storage tank 23; when the device starts operation, power is supplied to the device, and the signal processor 27 is turned on;
liquid injection operation is performed, the water pump 24 is turned on, and the sixth valve 10-6, the seventh valve 10-7 and the third valve 10-3 are opened; a solution in the solution storage tank 23 is injected into the hydrate generation vessel 1 through the solution supply route; when the liquid level of the solution reaches a required height, the water pump 24 is turned off, and the sixth valve 10-6, the seventh valve 10-7 and the third valve 10-3 are closed to stop liquid injection;
the connection valve I 3 and the connection valve II 6 are opened to allow the solution in the hydrate generation vessel 1 to flow downwards into the hydrate decomposition vessel 7; when it is observed through the sight glass I 12 that the solution in the hydrate generation vessel 1 is fully drained, the connection valve I 3 and the connection valve II 6 are closed after a waiting time of 30 seconds;
the liquid injection operation is performed again, and the solution is injected into the hydrate generation vessel 1;
the mechanical stirrer I 9 and the mechanical stirrer II 18 are turned on, and a stirring speed is set;
the water bath I 25 is turned on, a water bath refrigeration temperature is set, and the hydrate generation vessel 1 and the solution therein are cooled through the refrigeration route;

### \textcircled{2} Hydrate Generation Process

when the temperature detected by the temperature sensor I 13 reaches a required value for reaction, the fourth valve 10-4 is opened to inject the gas from the gas source 22 into the hydrate generation vessel 1 through the gas injection route;
when the pressure detected by the pressure sensor I 11 reaches a required value for reaction, the fourth valve 10-4 is closed to stop gas injection, and this moment is recorded as a reaction start time;
when the reaction time T1 reaches a required reaction endpoint, this moment is recorded as a reaction end time;

### \textcircled{3} Gas Concentration Detection Process

the first valve 10-1 is opened to allow the remaining unreacted gas in the hydrate generation vessel 1 to pass through the gas concentration detection route and be analyzed by the gas composition detector 2; after sampling is completed, the first valve 10-1 is closed;

### \textcircled{4} Hydrate Slurry Transfer Process I

the connection valve I 3 is opened to allow the hydrate slurry formed in the hydrate generation vessel 1 to flow into the intermediate vessel 4 through the connection valve I 3; when the value of the pressure detected by the pressure sensor I 11 no longer decreases and remains stable for 5 seconds, the connection valve I 3 is closed;

### \textcircled{5} Waste Gas Discharge Process

the second valve 10-2 is opened to release the remaining gas in the hydrate generation vessel 1 to the atmosphere through the waste gas discharge route; when the value of the pressure detected by the pressure sensor I 11 is 0, the second valve 10-2 is closed;

### \textcircled{6} Solution Recirculation Process

the eighth valve 10-8, the seventh valve 10-7, the water pump 24 and the third valve 10-3 are opened, and the solution in the hydrate decomposition vessel 7 is injected into the hydrate generation vessel 1 through the solution recirculation route; when the liquid level of the solution reaches a required height, the water pump 24 is turned off, and the eighth valve 10-8, the seventh valve 10-7 and the third valve 10-3 are closed to stop liquid injection;

### \textcircled{7} Hydrate Slurry Transfer Process II

the connection valve II 6 is opened to allow the hydrate slurry in the intermediate vessel 4 to flow into the hydrate decomposition vessel 7 through the connection valve II 6;

### \textcircled{8} Hydrate Decomposition Process

the water bath II 26 is turned on, a heating temperature is set, and the hydrate decomposition vessel 7 and the hydrate slurry therein are heated through the heating route;
as the hydrate slurry begins to be decomposed into CO₂ gas and solution, the solution remains in the hydrate decomposition vessel 7 due to gravity, while the CO₂ gas escapes from the solution, rises and remains in the intermediate vessel 4;
when the reaction time T2 reaches a required decomposition endpoint, this moment is recorded as a decomposition end time;

### \textcircled{9} Co₂ Gas Collection Process

the ninth valve 10-9 is opened, the gas pump 5 is turned on, and the pure CO₂ gas obtained in the intermediate vessel 4 is collected into the decomposition gas collection bottle 28 through the decomposition gas collection route;
when the value of the pressure detected by the pressure sensor II 20 is 0, the ninth valve 10-9 is closed, and the gas pump 5 is turned off;

### \textcircled{10} Solution Recovery Process

the eighth valve 10-8, the seventh valve 10-7 and the fifth valve 10-5 are opened, the water pump 24 is turned on, and the solution is recovered to the solution storage tank 23 through the solution recovery route; when the water pump 24 reaches a set working value, the solution in the hydrate decomposition vessel 7 is fully drained; afterward, the water pump 24 is turned off, and the eighth valve 10-8, the seventh valve 10-7 and the fifth valve 10-5 are closed;

### \textcircled{11} Completion Process

after the reaction is completed, all valves are closed, the water bath I 25, the water bath II 26, the mechanical stirrer I 9 and the mechanical stirrer II 18 are turned off, and the power supply is disconnected.

The above mentioned embodiments only express several embodiments of the present invention, which are described in more specific and detailed, but are not to be construed as a limitation of the patent scope of the present invention. Technicians familiar with the field may also make various equivalent deformations such as replacing the composition and concentration of the gas source without violating the spirit of the present application, and these equivalent deformations are included in the scope limited by the claims of the present application.

1. A three-stage continuous CO₂ capture device based on hydrate technology, comprising: a hydrate generation vessel (1), a gas composition detector (2), a connection valve I (3), an intermediate vessel (4), a gas pump (5), a connection valve II (6), a hydrate decomposition vessel (7), ports, a mechanical stirrer I (9), valves, a pressure sensor I (11), a sight glass I (12), a temperature sensor I (13), a jacket I (14-1), a jacket II (14-2), fixing bolts (15), a sight glass II (16), a temperature sensor II (17), a mechanical stirrer II (18), a one-way valve (19), a pressure sensor II (20), a booster pump (21), a gas source (22), a solution storage tank (23), a water pump (24), a water bath I (25), a water bath II (26), a signal processor (27) and a decomposition gas collection bottle (28);
the main body of the device is a three-stage device, which is provided with the hydrate generation vessel (1), the connection valve I (3), the intermediate vessel (4), the connection valve II (6) and the hydrate decomposition vessel (7) from top to bottom in sequence;
the hydrate generation vessel (1) is a stainless steel cylindrical pressure-resistant container, with the sight glass I (12) installed at half of the height thereof, and the jacket I (14-1) welded around the outer perimeter thereof; a top cover and a bottom cover of the hydrate generation vessel (1) are respectively provided with evenly distributed fixing bolts (15); the top cover of the hydrate generation vessel (1) is provided with seven holes at a diameter position, through which the following components are installed from left to right in sequence: a gas injection port (8-1), a water injection port (8-2), a residual waste gas discharge port (8-3), a mechanical stirrer I installation port (8-11), a pressure sensor I port (8-6), a gas composition detection port (8-5) and a temperature sensor I port (8-4); a motor part of the mechanical stirrer I (9) is located outside the top cover of the hydrate generation vessel (1), while a main shaft of the mechanical stirrer I (9) extends into the hydrate generation vessel (1); the pressure sensor I port (8-6) is connected upwards to the pressure sensor I (11), and the temperature sensor I port (8-4) is connected upwards to the temperature sensor I (13); the bottom of the hydrate generation vessel (1) is provided with a communication hole which is connected to the connection valve I (3) below;
a valve chamber passage of the connection valve I (3) is aligned with the communication hole in the bottom cover of the hydrate generation vessel (1), a valve stem of the connection valve I (3) is horizontally connected to a valve body and a drive shaft of the connection valve I (3), and the bottom of the connection valve I (3) is connected to a top cover communication hole of the intermediate vessel (4);
the intermediate vessel (4) is a stainless steel cylindrical pressure-resistant container, a top cover and a bottom cover are respectively provided with evenly distributed fixing bolts (15) and communication holes, the top cover is provided with a decomposition gas discharge port (8-7), and a communication hole in the bottom of the intermediate vessel (4) is connected to the connection valve II (6) below;
a valve chamber passage of the connection valve II (6) is aligned with the communication hole in a top cover of the hydrate decomposition vessel (7), a valve stem of the connection valve II (6) is horizontally connected to a valve body and a drive shaft of the connection valve II (6), and the bottom of the connection valve II (6) is connected to a top cover communication hole of the hydrate decomposition vessel (7);
the hydrate decomposition vessel (7) is a stainless steel cylindrical pressure-resistant container, with the sight glass II (16) installed at half of the height thereof, and the jacket II (14-2) welded around the outer perimeter thereof;
the top cover and a bottom cover of the hydrate decomposition vessel (7) are respectively provided with evenly distributed fixing bolts (15); the top cover of the hydrate decomposition vessel (7) is provided with a communication hole which is connected to the connection valve II (6) above; the bottom cover of the hydrate decomposition vessel (7) is provided with five holes at a diameter position, through which the following components are installed from left to right in sequence: a liquid discharge port (8-8), a mechanical stirrer II installation port (8-12) a pressure sensor II port (8-9) and a temperature sensor II port (8-10); a motor part of the mechanical stirrer II (18) is located outside the bottom cover of the hydrate decomposition vessel (7), while a main shaft of the mechanical stirrer II (18) extends into the hydrate decomposition vessel (7); the pressure sensor II port (8-9) is connected downwards to the pressure sensor II (20), and the temperature sensor II port (8-10) is connected downwards to the temperature sensor II (17);
the device comprises the following routes: a gas injection route, a waste gas discharge route, a solution circulation route, a solution supply route, a solution recirculation route, a solution recovery route, a gas concentration detection route, a signal transmission route, a decomposition gas collection route, a refrigeration route and a heating route.

2. The three-stage continuous CO₂ capture device based on hydrate technology according to claim 1, wherein
The routes of the device are specifically as follows:
gas injection route: the gas source (22) is connected to the gas injection port (8-1) of the hydrate generation vessel (1) through a fourth valve (10-4), the booster pump (21) and a pipeline III;
waste gas discharge route: the residual waste gas discharge port (8-3) of the hydrate generation vessel (1) is connected to the atmosphere through a second valve (10-2) and a pipeline I;
solution circulation route: starting from the water injection port (8-2) of the hydrate generation vessel (1), the route is connect to a pipeline IX through a pipeline II and a third valve (10-3); the pipeline IX is divided into two branches at the end; a left branch is connected to the top end of the solution storage tank (23) through a fifth valve (10-5) and a pipeline X, and the bottom end of the solution storage tank (23) is connected to a pipeline XIII through a sixth valve (10-6) and a pipeline XII; a right branch is connected to the water pump (24) through a pipeline XI, and is then merged with the pipeline XIII through a seventh valve (10-7); at the junction, the route is connected to the liquid discharge port (8-8) of the hydrate decomposition vessel (7) through an eighth valve (10-8) and a pipeline XIV;
solution supply route: the bottom end of the solution storage tank (23) is connected to the water injection port (8-2) of the hydrate generation vessel (1) through the sixth valve (10-6), the pipeline XII, the pipeline XIII, the seventh valve (10-7), the water pump (24), the pipeline XI, the pipeline IX, the third valve (10-3) and the pipeline II;
solution recirculation route: the liquid discharge port (8-8) of the hydrate decomposition vessel (7) is connected to the water injection port (8-2) of the hydrate generation vessel (1) through the pipeline XIV, the eighth valve (10-8), the seventh valve (10-7), the water pump (24), the pipeline XI, the pipeline IX, the third valve (10-3) and the pipeline II;
solution recovery route: the liquid discharge port (8-8) of the hydrate decomposition vessel (7) is connected to the top end of the solution storage tank (23) through the pipeline XIV, the eighth valve (10-8), the seventh valve (10-7), the water pump (24), the pipeline XI, the fifth valve (10-5) and the pipeline X;
gas concentration detection route: the gas composition detection port (8-5) of the hydrate generation vessel (1) is connected to the gas composition detector (2) through a first valve (10-1) and a pipeline V;
signal transmission route 1: the pressure sensor I (11) is connected to the signal processor (27) through a signal circuit IV;
signal transmission route 2: the rear end of the gas composition detector (2) is connected to the signal processor (27);
signal transmission route 3: the temperature sensor I (13) is connected to the signal processor (27) through a signal circuit VI;
signal transmission route 4: the pressure sensor II (20) is connected to the signal processor (27) through a signal circuit XV;
signal transmission route 5: the temperature sensor II (17) is connected to the signal processor (27) through a signal circuit XIX;
decomposition gas collection route: the decomposition gas discharge port (8-7) of the intermediate vessel (4) is connected to the decomposition gas collection bottle (28) through a ninth valve (10-9), a pipeline XVI, and the gas pump (5);
refrigeration route: the jacket I (14-1) is connected to a liquid outlet of the water bath I (25) through a pipeline VIII, and the jacket I (14-1) is connected to a liquid return port of the water bath I (25) through a pipeline VII;
heating route: the jacket II (14-2) is connected to a liquid outlet of the water bath II (26) through a pipeline XVIII, and the jacket II (14-2) is connected to a liquid return port of the water bath II (26) through a pipeline XVII.

3. The three-stage continuous CO₂ capture device based on hydrate technology according to claim 1, wherein
the bottom end of the main shaft of the mechanical stirrer I (9) is 10 cm from the bottom cover of the hydrate generation vessel (1), and paddle-type stirring blades are welded on the main shaft; the blades are distributed in pairs on the main shaft at equal intervals from top to bottom, a first group is positioned 10 cm from the top end of the main shaft, and a last group is welded on the bottom end of the main shaft.

4. The three-stage continuous CO₂ capture device based on hydrate technology according to claim 1, wherein
the bottom end of the main shaft of the mechanical stirrer II (18) is 10 cm from the top end of the hydrate decomposition vessel (7), and paddle-type stirring blades are welded on the main shaft; the blades are distributed in pairs on the main shaft at equal intervals from top to bottom, a first group is positioned 10 cm from the top end of the main shaft, and a last group is welded on the bottom end of the main shaft.

5. The three-stage continuous CO₂ capture device based on hydrate technology according to claim 1, wherein
the internal volume of the hydrate generation vessel (1) is V, the internal volume of the intermediate vessel (4) is ⅔V, and the internal volume of the hydrate decomposition vessel (7) is also ⅔V.

6. The three-stage continuous CO₂ capture device based on hydrate technology according to claim 1, wherein
the gas source (22) is a pressure-resistant container rated for 10 MPa, with a volume of ≥10V, and is used for storing a mixed gas of CO₂ and N₂ as a feed gas of the device; the solution storage tank (23) has a volume of ≥2V; the decomposition gas collection bottle (28) is a pressure-resistant container rated for 10 MPa, with a volume of ≥10V, and is used for storing pure CO₂.

7. A method for using the three-stage continuous CO₂ capture device based on hydrate technology according to claim 2, comprising the following processes: \textcircled{1} preparation process, \textcircled{2} hydrate generation process, \textcircled{3} gas concentration detection process, \textcircled{4} hydrate slurry transfer process I, \textcircled{5} waste gas discharge process, \textcircled{6} solution recirculation process, \textcircled{7} hydrate slurry transfer process II, \textcircled{8} hydrate decomposition process, \textcircled{9} CO₂ gas collection process, \textcircled{10} solution recovery process and \textcircled{11} completion process;
according to a chronological order, the operation of the device is divided into three stages; the first stage is \textcircled{1}→\textcircled{2}→\textcircled{3}→\textcircled{4}→\textcircled{5}→\textcircled{6}→\textcircled{7}; after process \textcircled{7}, the second stage of the operation of the device occurs; the second stage is divided into two concurrent routes: route 1 is \textcircled{8}→\textcircled{9}, and route 2 is \textcircled{2}→\textcircled{3}→\textcircled{4}→\textcircled{5}→\textcircled{6}→\textcircled{7}; both routes start and end simultaneously, and the total time spent is equal; after repeating the second stage for N times, the third stage of the operation of the device is carried out, which is \textcircled{10}→\textcircled{4}→\textcircled{5}→\textcircled{7}→\textcircled{10}→\textcircled{11}; thus, the entire continuous carbon capture work is completed.

8. The method according to claim 7, wherein
\textcircled{1} preparation process:
before the device starts operation, all valves are kept in a closed position, and a certain amount of solution is pre-stored in the solution storage tank (23); when the device starts operation, power is supplied to the device, and the signal processor (27) is turned on;
liquid injection operation is performed, the water pump (24) is turned on, and the sixth valve (10-6), the seventh valve (10-7) and the third valve (10-3) are opened; a solution in the solution storage tank (23) is injected into the hydrate generation vessel (1) through the solution supply route; when the liquid level of the solution reaches a required height, the water pump (24) is turned off, and the sixth valve (10-6), the seventh valve (10-7) and the third valve (10-3) are closed to stop liquid injection;
the connection valve I (3) and the connection valve II (6) are opened to allow the solution in the hydrate generation vessel (1) to flow downwards into the hydrate decomposition vessel (7); when it is observed through the sight glass I (12) that the solution in the hydrate generation vessel (1) is fully drained, the connection valve I (3) and the connection valve II (6) are closed after a waiting time of 30 seconds;
the liquid injection operation is performed again, and the solution is injected into the hydrate generation vessel (1);
the mechanical stirrer I (9) and the mechanical stirrer II (18) are turned on, and a stirring speed is set;
the water bath I (25) is turned on, a water bath refrigeration temperature is set, and the hydrate generation vessel (1) and the solution therein are cooled through the refrigeration route;
\textcircled{2} hydrate generation process:
when the temperature detected by the temperature sensor I (13) reaches a required value for reaction, the fourth valve (10-4) is opened to inject the gas from the gas source (22) into the hydrate generation vessel (1) through the gas injection route;
when the pressure detected by the pressure sensor I (11) reaches a required value for reaction, the fourth valve (10-4) is closed to stop gas injection, and this moment is recorded as a reaction start time;
when the reaction time T1 reaches a required reaction endpoint, this moment is recorded as a reaction end time;
\textcircled{3} gas concentration detection process:
the first valve (10-1) is opened to allow the remaining unreacted gas in the hydrate generation vessel (1) to pass through the gas concentration detection route and be analyzed by the gas composition detector (2); after sampling is completed, the first valve (10-1) is closed;
\textcircled{4} hydrate slurry transfer process I:
the connection valve I (3) is opened to allow the hydrate slurry formed in the hydrate generation vessel (1) to flow into the intermediate vessel (4) through the connection valve I (3); when the value of the pressure detected by the pressure sensor I (11) no longer decreases and remains stable for 5 seconds, the connection valve I (3) is closed;
\textcircled{5} waste gas discharge process:
the second valve (10-2) is opened to release the remaining gas in the hydrate generation vessel (1) to the atmosphere through the waste gas discharge route; when the value of the pressure detected by the pressure sensor I (11) is 0, the second valve (10-2) is closed;
\textcircled{6} solution recirculation process:
the eighth valve (10-8), the seventh valve (10-7), the water pump (24) and the third valve (10-3) are opened, and the solution in the hydrate decomposition vessel (7) is injected into the hydrate generation vessel (1) through the solution recirculation route; when the liquid level of the solution reaches a required height, the water pump (24) is turned off, and the eighth valve (10-8), the seventh valve (10-7) and the third valve (10-3) are closed to stop liquid injection;
\textcircled{7} hydrate slurry transfer process II:
the connection valve II (6) is opened to allow the hydrate slurry in the intermediate vessel (4) to flow into the hydrate decomposition vessel (7) through the connection valve II (6);
\textcircled{8} hydrate decomposition process:
the water bath II (26) is turned on, a heating temperature is set, and the hydrate decomposition vessel (7) and the hydrate slurry therein are heated through the heating route;
as the hydrate slurry begins to be decomposed into CO₂ gas and solution, the solution remains in the hydrate decomposition vessel (7) due to gravity, while the CO₂ gas escapes from the solution, rises and remains in the intermediate vessel (4);
when the reaction time T2 reaches a required decomposition endpoint, this moment is recorded as a decomposition end time;
\textcircled{9} CO₂ gas collection process:
the ninth valve (10-9) is opened, the gas pump (5) is turned on, and the pure CO₂ gas obtained in the intermediate vessel (4) is collected into the decomposition gas collection bottle (28) through the decomposition gas collection route;
when the value of the pressure detected by the pressure sensor II (20) is 0, the ninth valve (10-9) is closed, and the gas pump (5) is turned off;
\textcircled{10} solution recovery process:
the eighth valve (10-8), the seventh valve (10-7) and the fifth valve (10-5) are opened, the water pump (24) is turned on, and the solution is recovered to the solution storage tank (23) through the solution recovery route; when the water pump (24) reaches a set working value, the solution in the hydrate decomposition vessel (7) is fully drained; afterward, the water pump (24) is turned off, and the eighth valve (10-8), the seventh valve (10-7) and the fifth valve (10-5) are closed;
\textcircled{11} completion process:
after the reaction is completed, all valves are closed, the water bath I (25), the water bath II (26), the mechanical stirrer I (9) and the mechanical stirrer II (18) are turned off, and the power supply is disconnected.
